(19) United States
(12) Patent Application Publication
(10) Pub. No.: US 2026/0352413 A1
(43) Pub. Date: Nov. 5, 2026

(54) REFERENCE SIGNAL INSERTION METHOD FOR PASSIVE IOT

(71) Applicant: ZTE CORPORATION, Shenzhen, Guangdong (CN)

(72) Inventors: Yihua MA, Shenzhen, Guangdong (CN); Zhifeng YUAN, Shenzhen, Guangdong (CN); Bo DAI, Shenzhen, Guangdong (CN); Kun LIU, Shenzhen, Guangdong (CN)

(21) Appl. No.: 19/487,197

(22) PCT Filed: Jun. 2, 2023
(86) PCT No.: PCT/CN2023/098125

§ 371 Date: Nov. 24, 2025

(51) Int. Cl. H04L 5/00; H04W 56/00

(52) U.S. Cl. CPC H04L 5/0051; H04W 56/001

(57) ABSTRACT

A wireless communication method for use in a first node is disclosed. The method comprises performing a communication, with a second node, for a data signal in a period, wherein, in the period of performing the communication, at least one reference signal is transmitted from the first node to the second node.

### CROSS-REFERENCES TO RELATED APPLICATIONS

This application is a U.S. National Phase application of International Application No. PCT/CN2023/098125, filed on Jun. 2, 2023. The disclosure of the above-mentioned application is incorporated herein by reference in its entirety.

### TECHNICAL FIELD

This document is directed generally to wireless communications, and in particular to 5G communications and more particular to 6G communications.

### BACKGROUND

The 6G system is expected to connect a massive number of IoT (Internet-of-Things) devices. To make IoT devices widespread and convenient, the cost and power of the IoT devices need to be reduced.

### SUMMARY

This document relates to methods, systems, and devices for communications of IoT devices, and in particular to methods, systems, and devices for communications of passive IoT devices.

The present disclosure relates to a wireless communication method for use in a first node. The method comprises:
performing a communication, with a second node, for a data signal in a period,
wherein, in the period of performing the communication, at least one reference signal is transmitted from the first node to the second node.

Various embodiments may preferably implement the following features:

Preferably, each reference signal comprises at least one of a delimiter, at least one pulse interval encoding (PIE) data symbol, or at least one pulse.

Preferably, the at least one pulse has a pulse width wider than a pulse width of the PIE data symbol.

Preferably, the data signal is modulated by using a PIE.

Preferably, each reference signal comprises the at least one PIE data symbol.

Preferably, performing the communication, with a second node, for the data signal in the period comprises transmitting, to the second node, the data signal in the period.

Preferably, performing the communication, with the second node, for the data signal in the period comprises:
transmitting, to the second node, at least one excitation signal in the period, and
receiving, from the second node, the data signal, wherein the data signal is generated by backscattering the at least one excitation signal.

Preferably, each reference signal comprises the excitation signal and a delimiter.

Preferably, a synchronization error of the data signal higher exceeds a threshold.

Preferably, the at least one reference signal is transmitted at intervals with a fixed time.

Preferably, the at least one reference signal is transmitted at intervals corresponding to a fixed number of data symbols of the data signal.

The present disclosure relates to a wireless communication method for use in a second node. The method comprises:
performing a communication, with a first node, for a data signal in a period, wherein, in the period of performing the communication, at least one reference signal is transmitted from the first node to the second node, and
synchronizing with the first node based on the at least one reference signal during the period of performing the communication.

Various embodiments may preferably implement the following features:

Preferably, each reference signal comprises at least one of a delimiter, at least one pulse interval encoding (PIE) data symbol, or at least one pulse.

Preferably, the at least one pulse has a pulse width wider than a pulse width of the PIE data symbol.

Preferably, the data signal is modulated by using a PIE.

Preferably, each reference signal comprises the at least one PIE data symbol.

Preferably, performing the communication, with the first node, for the data signal in the period comprises: receiving, from the first node, the data signal in the period.

Preferably, performing the communication, with the first node, for the data signal in the period comprises: transmitting, to the first node, the data signal in the period by backscattering at least one excitation signal transmitted from the first node.

Preferably, each reference signal comprises the excitation signal and a delimiter.

Preferably, the at least one reference signal is received at intervals with a fixed time.

Preferably, the at least one reference signal is received at intervals corresponding to a fixed number of data symbols of the data signal.

The present disclosure relates to a first node. The first node comprises:
a communication unit, and
a processor, configured to perform a communication, with a second node by using the communication unit, for a data signal comprising at least one in a period wherein, in the period of performing the communication, at least one reference signal is transmitted from the first node to the second node.

Various embodiments may preferably implement the following feature:

Preferably, the processor is further configured to perform any of the aforementioned wireless communication methods.

The present disclosure relates to a second node. The second node comprises:
a communication unit, and
a processor, configured to:
perform a communication, with a first node by using the communication unit, for a data signal in a period, wherein, in the period of performing the communication, at least one reference signal is transmitted from the first node to the second node, and
synchronize with the first node based on the at least one reference signal during the period of performing the communication.

Various embodiments may preferably implement the following feature:

Preferably, the processor is further configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF THE DRAWINGS

FIG. 1 shows a schematic diagram of a communication between a reader and a tag according to an embodiment of the present disclosure.

FIG. 2 shows a schematic diagram of an uplink transmission according to an embodiment of the present disclosure.

FIG. 3 shows a schematic diagram of an uplink transmission according to an embodiment of the present disclosure.

FIG. 4 shows a schematic diagram of an uplink transmission according to an embodiment of the present disclosure.

FIG. 5 shows a schematic diagram of a downlink transmission according to an embodiment of the present disclosure.

FIG. 6 shows a schematic diagram of a downlink transmission according to an embodiment of the present disclosure.

FIG. 7 shows a schematic diagram of a downlink transmission according to an embodiment of the present disclosure.

FIG. 8 shows a schematic diagram of a network (architecture) according to an embodiment of the present disclosure.

FIG. 9 shows an example of a schematic diagram of a wireless terminal according to an embodiment of the present disclosure.

FIG. 10 shows an example of a schematic diagram of a wireless network node according to an embodiment of the present disclosure.

FIG. 11 shows a flowchart of a method according to an embodiment of the present disclosure.

FIG. 12 shows a flowchart of a method according to an embodiment of the present disclosure.

### DETAILED DESCRIPTION OF THE EMBODIMENTS

In the present disclosure, passive IoT technology is used, so as to reduce the cost and power of the IoT devices.

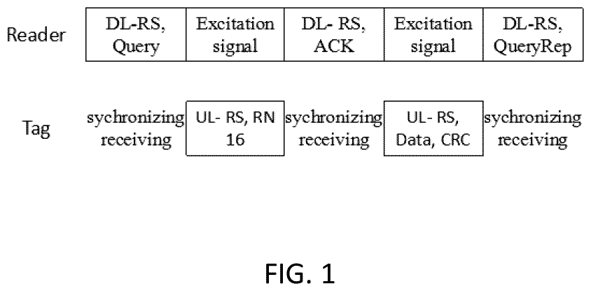

FIG. 1 shows a schematic diagram of a communication between a reader and a tag according to an embodiment of the present disclosure. In FIG. 1, the downlink reference signal (DL-RS) is inserted together with the downlink signaling. For example, the DL reference signal may comprise at least one of a Query, an acknowledge message (ACK), or a QueryRep. As shown in FIG. 1, the DL-RS only appears once in a DL transmission or before an uplink (UL) transmission. In a cellular system, the reader may be a base station or a non-passive user-equipment (UE), while the tag may be a passive IoT device. The excitation signal is a continuous-wave signal, which may be a single-tone. When the reader is a UE, the DL-RS may be a sidelink reference signal.

In the present disclosure, the data (bit/signal) may be modulated by using pulse interval encoding (PIE).

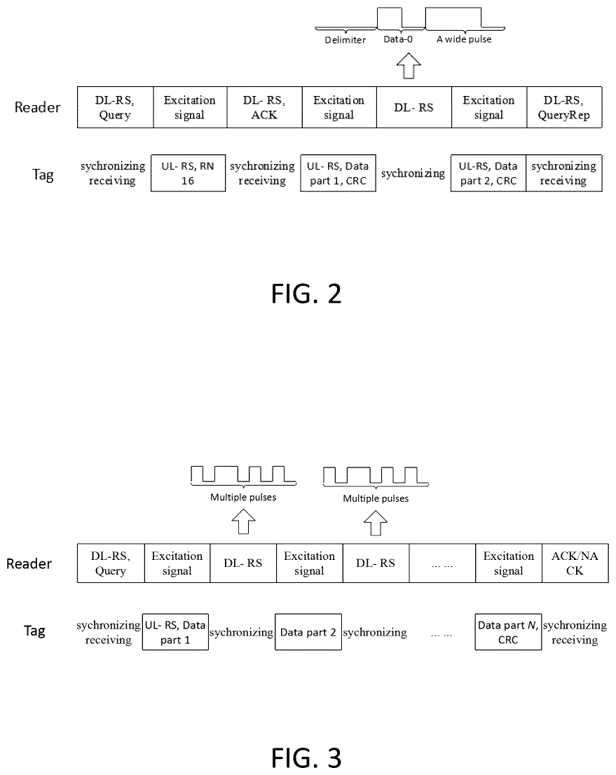

FIG. 2 shows a schematic diagram of an uplink transmission according to an embodiment of the present disclosure. In this embodiment, a downlink reference signal insertion method in the uplink data transmission is proposed. Before the uplink data transmission, a query (and DL-RS) is sent by the reader and the tag responses a random number. The reader further transmits this random number in the downlink transmission as an ACK to the tag. The reader transmits an excitation signal and the tag begins transmitting a UL data signal via backscattering the excitation signal. In this embodiment, uplink data is divided into two parts. After a transmission of a data part 1 finishes, the reader transmits a DL-RS and the tag synchronizes with the reader by using this DL-RS. After synchronizing with the reader again based on the DL-RS, the tag transmits a data part 2. After the reader receives the whole data, a new round of query is started via sending the QueryRep to the tag.

In FIG. 2, the DL-RS comprises a delimiter which is always low, a PIE data-0 symbol (i.e., the PIE symbol indicating the data bit ‘0’) and a wide pulse. In addition, in this embodiment, the DL-RS may be inserted when/if a synchronization error of the received data part 1 exceeds a threshold. This dedicated DL-RS structure is robust to prevent wrong detection.

In an embodiment, the wide pulse has a pulse width greater/wider than a PIE data symbol comprised in the UL data signal.

FIG. 3 shows a schematic diagram of an uplink transmission according to an embodiment of the present disclosure. In this embodiment, a downlink reference signal insertion method in the uplink data transmission is proposed. Before the uplink data transmission, a query is sent by the reader and the tag transmits the data to the reader after receiving the query for this tag. The reader transmits an excitation signal and the tag begins to transmit the uplink data signal via backscattering the excitation signal. In this embodiment, the uplink data is divided into N parts. After the transmission of the data part n (n=1 to N−1) completes, the reader transmits a DL-RS and the tag performs the synchronization by using this DL-RS. After the synchronization, the tag transmits the data part n+1. After the reader receives the whole data, an ACK or NACK (non-ACK) is transmitted from the reader to the tag.

In FIG. 3, the DL-RS used for synchronization comprises multiple pulses. In addition, the DL-RSs are periodically inserted in the excitation signals. As an alternative or in addition, the DL-RS are inserted after a certain number of uplink (PIE) data symbols. This dedicated DL-RS structure is robust to prevent wrong detection and more flexibly designed.

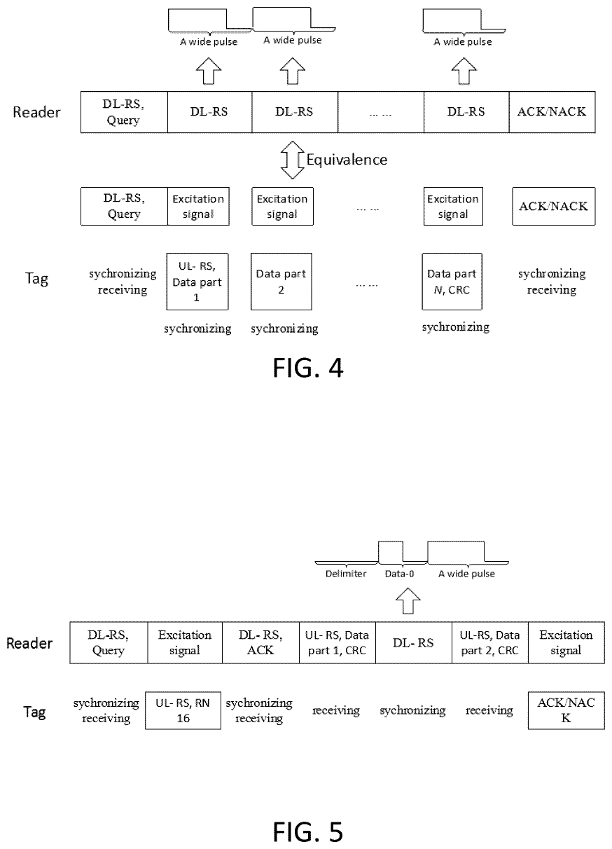

FIG. 4 shows a schematic diagram of an uplink transmission according to an embodiment of the present disclosure. In this embodiment, a downlink reference signal insertion method in the uplink data transmission is proposed. Before the uplink data transmission, a query is sent by the reader and the tag transmits the data to the reader after receiving the query for this tag. The reader consecutively transmits the DL-RSs which also act as the excitation signals. In this case, the DL-RS is/comprises a wide pulse. The high-voltage-level part of the DL-RS can be used as the excitation signal. Therefore, it can also be viewed as the transmitter transmits the excitation signals with gaps. The excitation signal and the gap form the DL-RS shown in FIG. 4.

In an embodiment, the wide pulse has a pulse width greater than the pulse width of at least one PIE data symbol comprised in the transmitted data. For example, the wide pulse may have a pulse width greater/wider than the time length of the PIE data symbols comprised in each data part.

The tag transmits the uplink data signal via backscattering the high-voltage-level part of the DL-RS (i.e., the excitation signal). The uplink data is divided into N parts. After the transmission of the data part n (n=1~N−1) transmission finishes, the tag synchronizes with the reader by using the n-th DL-RS and transmits the data part n+1. After the reader receives the whole data, the ACK or NACK is transmitted from the reader to the tag. This embodiment reuses the excitation signal and saves the resource overheads.

FIG. 5 shows a schematic diagram of a downlink transmission according to an embodiment of the present disclosure. In this embodiment, a downlink reference signal insertion method in the downlink data transmission is proposed. Before the uplink data transmission, a query is sent by the reader and the tag responses a random number. The reader further transmits this random number in the downlink as an ACK of the tag. The reader begins to transmit the uplink data signal using a PIE modulation. The downlink data is divided into two parts. After the data part 1 transmission is finished, the reader transmits a DL-RS, and the tag synchronizes using this DL-RS. Then, the data part 2 is transmitted. After the tag receives the whole data, an ACK or NACK is sent.

In this embodiment, the DL-RS comprises a delimiter which is always low, a PIE data-0 symbol and a wide pulse. This dedicated DL-RS structure is robust to prevent wrong detection.

In an embodiment, the wide pulse has a pulse width greater/wider than a PIE data symbol comprised in the downlink data.

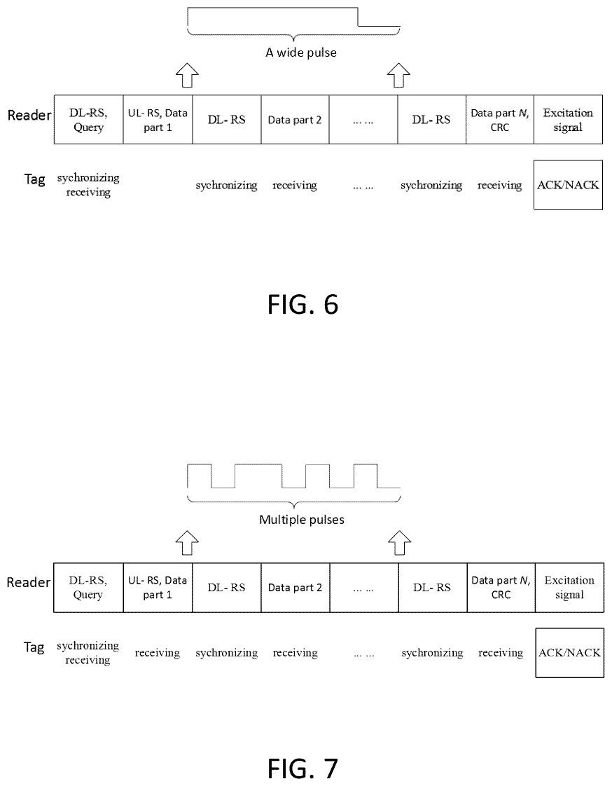

FIG. 6 shows a schematic diagram of a downlink transmission according to an embodiment of the present disclosure. In this embodiment, a downlink reference signal insertion method in the downlink data transmission is proposed. Before the uplink data transmission, a query is sent by the reader and the tag starts to receive after receiving the query for this tag. The reader transmits downlink data via the PIE modulation. The downlink data is divided into N parts. After the data part n (n=1~N−1) transmission is finished, the reader transmits a DL-RS, and the tag synchronizes using this DL-RS. Then, the data part n+1 is transmitted. After the tag receives the whole data, an ACK or NACK is transmitted from the tag to the reader.

In this embodiment, the DL-RS is a wide pulse. Here, the DL-RSs are periodically inserted in the downlink PIE data signals, or the DL-RSs are inserted after a certain number of downlink PIE data symbols. This dedicated DL-RS structure is simple and friendly to the low-power device.

FIG. 7 shows a schematic diagram of a downlink transmission according to an embodiment of the present disclosure. In this embodiment, a downlink reference signal insertion method in the downlink data transmission is proposed. Before the uplink data transmission, a query is sent by the reader and the tag starts to receive after receiving the query for this tag. The reader transmits downlink data via PIE modulation. The downlink data is divided into N parts. After the data part n (n=1~N−1) transmission is finished, the reader transmits a DL-RS, and the tag synchronizes using this DL-RS. Then, the data part n +1 is transmitted. After the tag receives the whole data, an ACK or NACK is transmitted from the tag to the reader.

In this embodiment, the DL-RS comprises multiple pulses. Here, the DL-RSs are periodically inserted in the downlink PIE data signals, or the DL-RSs are inserted after a certain number of downlink PIE data symbols. This dedicated DL-RS structure is robust to prevent wrong detection and more flexibly designed.

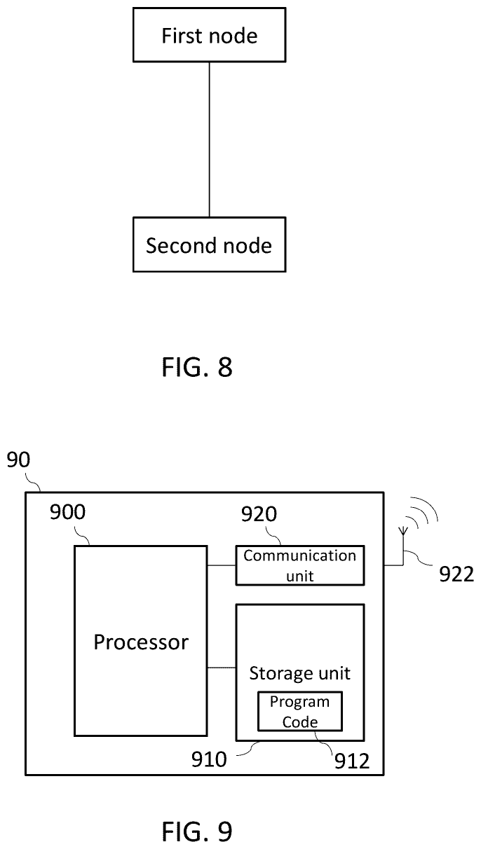

FIG. 8 shows a schematic diagram of a network (architecture) according to an embodiment of the present disclosure. The network (architecture) shown in FIG. 8 comprises a first node and a second node communicating with each other. In an embodiment, the first node is a BS (e.g., a gNB, a RAN node), a reader (of RFID) or a UE. In an embodiment, the second node is a UE or an IoT device or a tag (of RFID).

In an embodiment, a first wireless device (e.g., the first node shown in FIG. 8) transmits at least one downlink reference signal to a low-cost transceiver (e.g., second node). Note that the at least one downlink reference signal is transmitted between two data transmissions or at the same time of the data transmissions with a low-cost transceiver (e.g., IoT device).

In an embodiment, the data transmitted/received in the data transmissions is modulated by the PIE.

In an embodiment, the reference signal comprises at least one pulse.

In an embodiment, the reference signal comprises at least one of a delimiter (e.g., a signal kept at logical-level corresponding to bit 0, PIE data symbol(s), or a wide pulse.

In an embodiment, the wide pulse refers to the pulse having a pulse width greater than that of at least one PIE data symbol.

The data transmissions are in an uplink data transmission (see, e.g., FIGS. 1, 2, or 3).

In an embodiment, the at least one reference signal is inserted after a certain time duration or at intervals.

In an embodiment, the at least one reference signal is inserted after a certain number of uplink data symbols.

In an embodiment, at least part of the downlink reference signal is used/configured as the excitation signal.

In an embodiment, each downlink reference signal comprises an excitation signal and a delimiter.

In an embodiment, the data transmission is in a downlink transmission.

In an embodiment, the at least one downlink reference signal is periodically inserted in the downlink data transmission.

In an embodiment, the at least one reference signal is inserted after a certain time duration or at intervals.

The at least one downlink reference signal is inserted after a certain number of downlink data symbols.

In an embodiment, the first wireless device transmits an excitation signal to a second wireless device (e.g., second node); and the second wireless device backscatters a data signal to the first wireless device. In the time duration of the second wireless device backscatters the data signal, the first wireless device transmits a reference signal to the second wireless device when a certain condition related to this transmission is satisfied/met.

In an embodiment, the reference signal comprises at least one pulse.

In an embodiment, the reference signal comprises at least one of the delimiter, PIE data symbol(s), or a wide pulse.

In an embodiment, the wide pulse refers to the pulse with a pulse width greater than that of at least one PIE data symbol.

In an embodiment, the certain condition is/comprises a certain time passes.

In an embodiment, the certain condition is/comprises a certain number of transmission data symbols are counted.

In an embodiment, the certain condition is/comprises the first wireless device detects that a synchronization error of the backscattering signal becomes higher a threshold.

In an embodiment, at least part of the reference signal is used as the excitation signal.

In an embodiment, the reference signal comprises an excitation signal and a delimiter.

In an embodiment, the first wireless device transmits a data signal to a second wireless device. In the time duration of the data signal transmission, the first wireless device transmits a reference signal to the second wireless device when/if a certain condition related to this transmission is satisfied.

In an embodiment, the reference signal comprises at least one pulse.

In an embodiment, the reference signal comprises at least one of the delimiter, PIE data symbol(s), or a wide pulse.

In an embodiment, the wide pulse refers to the pulse with a pulse width wider than that of at least one PIE data symbol(s).

In an embodiment, the certain condition is/comprises a certain time passes. In this embodiment, the reference signal is transmitted at (fixed) intervals.

In an embodiment, the certain condition is/comprises a certain number of transmission data symbols are counted. In this embodiment, the reference signal is transmitted at intervals corresponding to the certain number of transmission data symbols. The interval may be approximately the same if the PIE data symbols have the same pulse width.

FIG. 9 relates to a schematic diagram of a wireless terminal 90 according to an embodiment of the present disclosure. The wireless terminal 90 may be a user equipment (UE), a mobile phone, a laptop, a tablet computer, an electronic book or a portable computer system and is not limited herein. The wireless terminal 90 may include a processor 900 such as a microprocessor or Application Specific Integrated Circuit (ASIC), a storage unit 910 and a communication unit 920. The storage unit 910 may be any data storage device that stores a program code 912, which is accessed and executed by the processor 900. Embodiments of the storage unit 910 include but are not limited to a subscriber identity module (SIM), read-only memory (ROM), flash memory, random-access memory (RAM), hard-disk, and optical data storage device. The communication unit 920 may a transceiver and is used to transmit and receive signals (e.g., messages or packets) according to processing results of the processor 900. In an embodiment, the communication unit 920 transmits and receives the signals via at least one antenna 922 shown in FIG. 9.

In an embodiment, the storage unit 910 and the program code 912 may be omitted and the processor 900 may include a storage unit with stored program code.

The processor 900 may implement any one of the steps in exemplified embodiments on the wireless terminal 90, e.g., by executing the program code 912.

The communication unit 920 may be a transceiver. The communication unit 920 may as an alternative or in addition be combining a transmitting unit and a receiving unit configured to transmit and to receive, respectively, signals to and from a wireless network node (e.g., a base station).

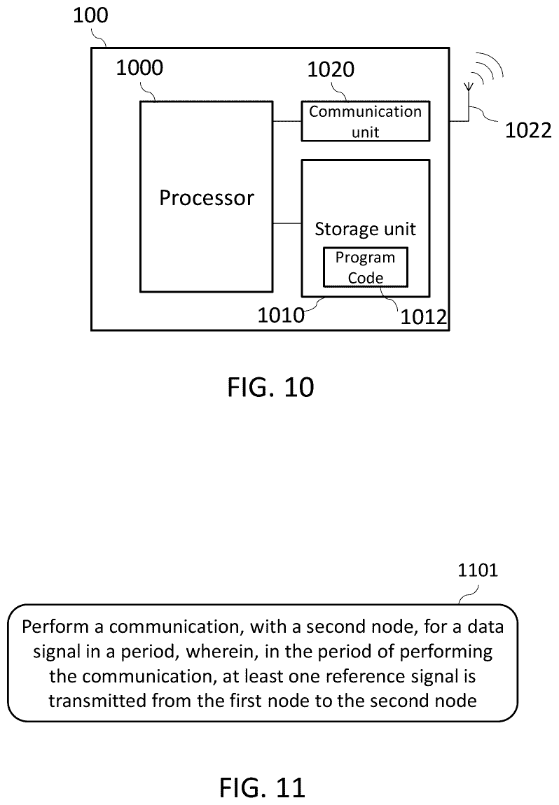

FIG. 10 relates to a schematic diagram of a wireless network node 100 according to an embodiment of the present disclosure. The wireless network node 100 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 100 may comprise (perform) at least one network function such as an access and mobility management function (AMF), a session management function (SMF), a user place function (UPF), a policy control function (PCF), an application function (AF), etc. The wireless network node 100 may include a processor 1000 such as a microprocessor or ASIC, a storage unit 1010 and a communication unit 1020. The storage unit 1010 may be any data storage device that stores a program code 1012, which is accessed and executed by the processor 1000. Examples of the storage unit 1010 include but are not limited to a SIM, ROM, flash memory, RAM, hard-disk, and optical data storage device. The communication unit 1020 may be a transceiver and is used to transmit and receive signals (e.g., messages or packets) according to processing results of the processor 1000. In an example, the communication unit 1020 transmits and receives the signals via at least one antenna 1022 shown in FIG. 10.

In an embodiment, the storage unit 1010 and the program code 1012 may be omitted. The processor 1000 may include a storage unit with stored program code.

The processor 1000 may implement any steps described in exemplified embodiments on the wireless network node 100, e.g., via executing the program code 1012.

The communication unit 1020 may be a transceiver. The communication unit 1020 may as an alternative or in addition be combining a transmitting unit and a receiving unit configured to transmit and to receive, respectively, signals to and from a wireless terminal (e.g., a user equipment or another wireless network node).

FIG. 11 shows a flowchart of a method according to an embodiment of the present disclosure. The method shown in FIG. 11 may be used in a first node and comprises the following step:

Step 1101: Perform a communication, with a second node, for a data signal in a period, wherein, in the period of performing the communication, at least one reference signal is transmitted from the first node to the second node.

In this embodiment, the first node performs a communication with a second node in a period. Within the period, the first node transmits at least one reference signal to the second node.

In an embodiment, the data signal is modulated by using the PIE.

In an embodiment, each reference signal comprises at least one of a delimiter, at least one PIE data symbol, or at least one pulse. Note that the reference signal may comprise the PIE data symbol(s) if the data signal is modulated by using the PIE.

In an embodiment, the at least one pulse has a pulse width wider than a pulse width of the PIE data symbol(s).

In an embodiment, the at least one pulse comprises at least one wide pulse, wherein the wide pulse refers to the pulse having a pulse width wider than a pulse width of the PIE data symbol(s).

In an embodiment, the first node performs the communication by transmitting, to the second node, the data signal in the period (i.e., downlink transmission).

In an embodiment, the first node performs the communication by transmitting, to the second node, at least one excitation signal in the period, and receiving, from the second node, the data signal, wherein the data signal is generated by backscattering the at least one excitation signal (i.e. UL transmission).

In an embodiment, each reference signal comprises the excitation signal and a delimiter (see, e.g., FIG. 4).

In an embodiment, the reference signal is transmitted when the first node determines/detects that a synchronization error of the data signal higher exceeds a threshold.

In an embodiment, the at least one reference signal is transmitted at intervals with a fixed time.

In an embodiment, the at least one reference signal is transmitted at intervals corresponding to a fixed number of data symbols of the data signal.

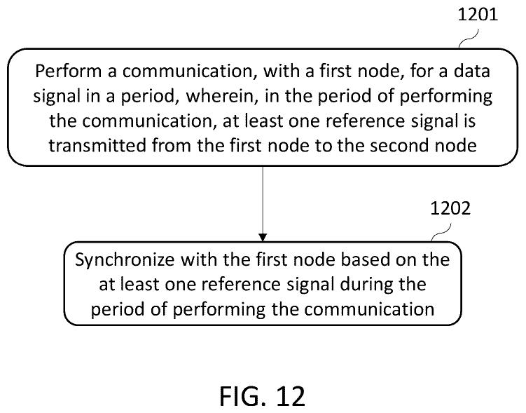

FIG. 12 shows a flowchart of a method according to an embodiment of the present disclosure. The method shown in FIG. 12 may be used in a second node and comprises the following steps:
Step 1201: Perform a communication, with a first node, for a data signal in a period, wherein, in the period of performing the communication, at least one reference signal is transmitted from the first node to the second node, and
Step 1202: Synchronize with the first node based on the at least one reference signal during the period of performing the communication.

In FIG. 12, the second node perform a communication with a first node for a data signal in a period. During the period of performing the communication, at least one reference signal is transmitted from the first node to the second node. Based on the at least one reference signal, the second node synchronizes with the first node within the period of performing the communication.

In an embodiment, the data signal is modulated by using the PIE.

In an embodiment, each reference signal comprises at least one of a delimiter, at least one PIE data symbol, or at least one pulse. Note that the reference signal may comprise the PIE data symbol(s) if the data signal is modulated by using the PIE.

In an embodiment, the at least one pulse has a pulse width wider than a pulse width of the PIE data symbol(s).

In an embodiment, the at least one pulse comprises at least one wide pulse, wherein the wide pulse refers to the pulse having a pulse width wider than a pulse width of the PIE data symbol(s).

In an embodiment, the second node performs the communication by receiving, from the first node, the data signal in the period (i.e. downlink transmission).

In an embodiment, the second node performs the communication by transmitting, to the first node, the data signal in the period by backscattering at least one excitation signal transmitted from the first node (i.e. UL transmission).

In an embodiment, each reference signal comprises the excitation signal and a delimiter (see, e.g., FIG. 4).

In an embodiment, the at least one reference signal is received at intervals with a fixed time.

In an embodiment, the at least one reference signal is received at intervals corresponding to a fixed number of data symbols of the data signal.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a first node, the method comprising:
performing a communication, with a second node, for a data signal in a period,
wherein, in the period of performing the communication, at least one reference signal is transmitted from the first node to the second node.

2. The wireless communication method of claim 1, wherein each reference signal comprises at least one of a delimiter, at least one pulse interval encoding (PIE) data symbol, or at least one pulse.

3. The wireless communication method of claim 2, wherein the at least one pulse has a pulse width wider than a pulse width of the PIE data symbol.

4. The wireless communication method of claim 2, wherein the data signal is modulated by using a PIE, and
wherein each reference signal comprises the at least one PIE data symbol.

5. The wireless communication method of claim 1, wherein performing the communication, with a second node, for the data signal in the period comprises:
transmitting, to the second node, the data signal in the period.

6. The wireless communication method of claim 1, wherein performing the communication, with the second node, for the data signal in the period comprises:
transmitting, to the second node, at least one excitation signal in the period, and
receiving, from the second node, the data signal, wherein the data signal is generated by backscattering the at least one excitation signal.

7. The wireless communication method of claim 6, wherein each reference signal comprises the excitation signal and a delimiter.

8. The wireless communication method of claim 6, wherein a synchronization error of the data signal higher exceeds a threshold.

9. The wireless communication method of claim 1, wherein the at least one reference signal is transmitted at intervals with a fixed time.

10. The wireless communication method of claim 1, wherein the at least one reference signal is transmitted at intervals corresponding to a fixed number of data symbols of the data signal.

11. A wireless communication method for use in a second node, comprising:
performing a communication, with a first node, for a data signal in a period, wherein, in the period of performing the communication, at least one reference signal is transmitted from the first node to the second node, and
synchronizing with the first node based on the at least one reference signal during the period of performing the communication.

12. The wireless communication method of claim 11, wherein each reference signal comprises at least one of a delimiter, at least one pulse interval encoding (PIE) data symbol, or at least one pulse.

13. The wireless communication method of claim 12, wherein the at least one pulse has a pulse width wider than a pulse width of the PIE data symbol.

14. The wireless communication method of claim 12, wherein the data signal is modulated by using a PIE, and
wherein each reference signal comprises the at least one PIE data symbol.

15. The wireless communication method of claim 11, wherein performing the communication, with the first node, for the data signal in the period comprises:
receiving, from the first node, the data signal in the period.

16. The wireless communication method of claim 11, wherein performing the communication, with the first node, for the data signal in the period comprises:
transmitting, to the first node, the data signal in the period by backscattering at least one excitation signal transmitted from the first node.

17. The wireless communication method of claim 16, wherein each reference signal comprises the excitation signal and a delimiter.

18. The wireless communication method of claim 11, wherein the at least one reference signal is received at intervals with a fixed time.

19. The wireless communication method of claim 11, wherein the at least one reference signal is received at intervals corresponding to a fixed number of data symbols of the data signal.

20-23. (canceled)

24. A computer program product, comprising a computer-readable program medium code stored thereupon, the code, when executed by a processor, causing the processor to implement the wireless communication method of claim 1.
